(19) United States
(12) Patent Application Publication
(10) Pub. No.: US 2005/0029696 A1
(43) Pub. Date: Feb. 10, 2005

(54) Method of manufacturing continuous foam from thermoplastic elastomeric material in atmosphere

(75) Inventors: Chun-Hsiung Wu, Tainan (TW); Ruey-Sheng Shih, Tainan (TW)

Correspondence Address: BACON & THOMAS, PLLC, 625 SLATERS LANE, FOURTH FLOOR, ALEXANDRIA, VA, 22314, US

(73) Assignee: MICROCELL COMPOSITE COMPANY, Tainan City (TW)

(21) Appl. No.: 10/824,466

(22) Filed: Apr. 15, 2004

(30) Foreign Application Priority Data
Aug. 7, 2003 (TW) 092121598

(51) Int. Cl. B29C 44/02

(52) U.S. Cl. 264/51; 264/160; 264/321

(57) ABSTRACT

The present invention is to provide a method of manufacturing continuous foam from a thermoplastic elastomeric composite in atmosphere, which comprises the steps of using thermoplastic elastomer as a raw material, adding different composing agent, foaming agent, and crosslinking agent into the raw material, kneading and rolling the raw material for forming a continuous sheet by means of a conventional rubber continuous foaming device, baking the sheet in an oven, foaming the heated sheet in a normal pressure, and cooling the foamed sheet to produce the foam material of the present invention.

### FIELD OF THE INVENTION

The present invention relates to a method of manufacturing foam from plastics and more particularly to a method of manufacturing continuous foam having properties of both typical rubber foam and plastic foam materials from a thermoplastic elastomeric material in atmosphere by taking advantage of the well known method of manufacturing continuous foam from rubber.

### BACKGROUND OF THE INVENTION

Conventionally, foam materials are classified as a rubber based foam material and a plastic based foam material depending on the raw material. Also, applications of rubber based foam material are different from that of plastic based foam material due to different properties thereof. For example, typically ethylene vinyl acetate (EVA) or a mixture of EVA and polyethylene (PE) is used as the raw material in the foaming process of manufacturing a plastic foam material. As such, the manufactured plastic foam material has advantages of being subject to cold-molding or hot-molding to form products having complicated shape, simple foaming recipe , and easy coloring. The foaming process and applications of products made therefrom are well known. For example, many consumer goods such as shoes, mats, or the like are made from a plastic foam material. Disadvantages thereof, however, are poor elasticity and poor slip resistance.

Moreover, typically a rubber material such as a mixture of polyvinyl chloride (PVC) and acrylonitrile butadiene rubber (NBR) is used as the raw material in the process of manufacturing a rubber foam material in atmosphere. The manufactured rubber foam material is without the disadvantages associated with the plastic foam material. Further, it has improved weather-proof and physical properties. As such, it is often used as material in manufacturing buoyant devices, pads, or the like. However, the recipe of the rubber foam compound are relatively complex. Also, dust is susceptible to generation in the manufacturing process, resulting in an environmental pollution. In addition, it has disadvantages of being difficult of post-molding to form products having complicated shape, and being difficult of recycling the waste material. Gradually, they are banned in use due to environmental pollution caused by PVC.

Thus, it is desirable to provide a method of manufacturing continuous foam having properties of both typical rubber foam and plastic foam materials from a thermoplastic elastomeric material by using the well known manufacturing process in order to improve the properties of foam material and increase applications thereof.

### SUMMARY OF THE INVENTION

A primary object of the present invention is to provide a method of manufacturing continuous foam from a thermoplastic elastomeric material in atmosphere. The method comprises using thermoplastic elastomer as a raw material, adding composing agent, foaming agent, and crosslinking agent and other additives into the raw material, kneading and rolling these material for forming a continuous sheet by means of a conventional rubber continuous foaming device, foaming the heated sheet in a normal pressure, and cooling the foamed sheet to produce the foam material of the present invention. By utilizing the present invention, the above drawbacks of the prior art can be overcome.

One object of the present invention is to use a conventional continuous foaming process by taking advantage of conventional continuous foaming techniques and devices in which the method comprises the steps of kneading and rolling are performed on the raw material for forming a continuous sheet, conveying the sheet to an oven, foaming the heated sheet in a normal pressure, rolling the foamed sheet, and producing the continuous foam material in rolls. In such a manner, it is possible of manufacturing a continuous foam material in rolls as a replacement of the current PVC/NBR mixture or any of other rubber foam materials formed of rubber.

Another object of the present invention is to, after kneading and rolling the thermoplastic elastomeric composite cut the continuous sheet into a plurality of sheet members with a predetermined size, stack a selected weight of sheet members in a mold to heat for forming a blank, and convey the blank to an oven to foam in a normal pressure (e.g., atmosphere). As such, it is possible of manufacturing a foam material having a predetermined shape from the thermoplastic elastomeric material in the normal pressure without having to greatly modifying the prior manufacturing processes.

Still another object of the present invention is to provide a continuous foam having advantages of good elasticity and being slip resistant as a typical rubber foam material, and simple recipe, easy coloring, easy post-processing, and recycling as a typical plastic foam material.

The above and other objects, features and advantages of the present invention will become apparent from the following detailed description taken with the accompanying drawings.

### BRIEF DESCRIPTION OF THE DRAWINGS

FIG. 1 is a flow chart illustrating a process according to a first preferred embodiment of the invention; and

FIG. 2 is a flow chart illustrating a process according to a second preferred embodiment of the invention.

### DETAILED DESCRIPTION OF THE PREFERRED EMBODIMENTS

The invention is directed to a method of manufacturing continuous foam from a thermoplastic elastomeric composite in atmosphere. The method comprises the steps of using thermoplastic elastomer as a raw material, adding different additive agent, foaming agent, and crosslinking agent into the raw material, kneading and rolling above materials for forming a continuous sheet by means of a conventional rubber continuous foaming process, then cutting the contrnuous sheet to an oven, foaming the heated sheet in a normal pressure (i.e., atmosphere), and cooling the foamed sheet to produce the foam material of the invention. The foam material not only has advantages of good elasticity and being slip resistant as a typical rubber foam material but also has advantages of simple recipe, easy coloring, easy post-processing, and recycling as a typical plastic foam material.

In the invention the thermoplastic elastomer as a raw material is selected from a styrenic thermoplastic elastomer such as styrene butadiene styrene (SBS), styrene-ethylene/butene-styrene (SEBS), or styrene isoprene styrene (SIS). In the raw material there are also added other rubber materials, thermoplastic elastomeric materials, or plastic materials in a predetermined weight percentage. Finally, add foaming agent, crosslinking agent, and composing other additive in a predetermined weight percentage into the raw material to produce the thermoplastic elastomer composite of the invention.

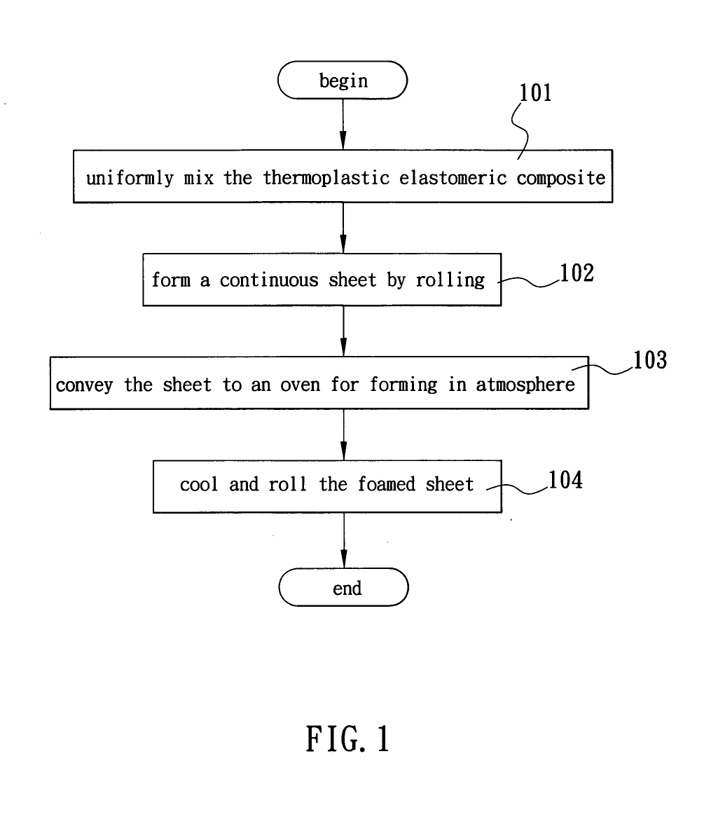

In the process according to a first preferred embodiment of the invention prior kneader, roll mill, and foaming device are used the same as that employed in a conventional one-stage based rubber continuous foaming process illustrated in a flow chart of FIG. 1. Kneading, rolling, and foaming steps are performed sequentially on the thermoplastic elastomeric composite to be processed and in which in step 101 the invention first pour components of the thermoplastic elastomeric composite in a predetermined weight percentage into a kneader, roll mill, and two-roll mill (or Banbury mixer) for uniformly mixing in a temperature ranged from about 90° C. to 130° C.; in step 102 convey the uniformly mixed thermoplastic elastomeric composite to a three-roll mill for rolling to form a continuous sheet with required width and thickness; in step 103 convey the continuous sheet to an oven to bake in a temperature ranged from about 150° C. to 180° C. in a normal pressure about one atmosphere for foaming the continuous sheet wherein the baking time of the continuous sheet is about 10 to 30 minutes depending on the size and the thickness of the sheet, and the foamed continuous sheet is then conveyed from the oven; and in step 104 finally cool the foamed continuous sheet and roll the same to produce the rolled, continuous foam material.

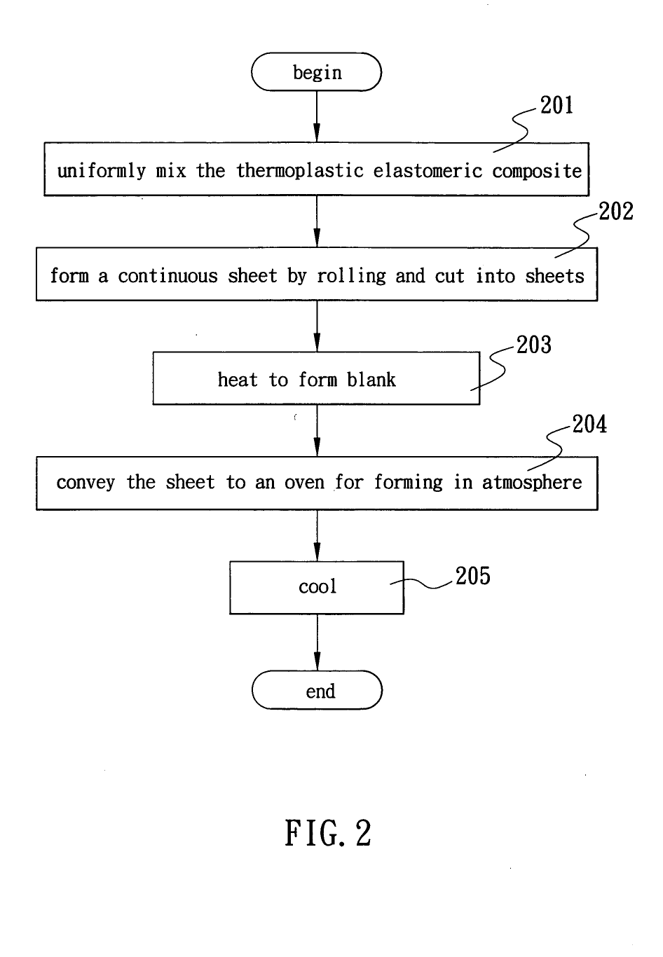

In the process according to a second preferred embodiment of the invention prior kneader, roll mill, and foaming device are used the same as that employed in a conventional two-stage based rubber continuous foaming process illustrated in a flow chart of FIG. 2. Kneading, rolling, and foaming steps are performed sequentially on the thermoplastic elastomeric composite to be processed and in which in step 201 the invention first pour components of the thermoplastic elastomeric composite in a predetermined weight percentage into a kneader, roll mill, and two-roll mill (or Banbury mixer) for uniformly mixing in a temperature ranged from about 90° C. to 130° C.; in step 202 convey the uniformly mixed thermoplastic elastomeric material to a two-roll mill for rolling a number of times to form a continuous sheet with required width prior to cutting into a plurality of sheet members with a predetermined size; in step 203 stack a selected weight of sheet members or a selected number of sheet members having a required weight and convey the same to a mold to heat in a temperature ranged from about 150° C. to 180° C. in a pressure about 90 to 250 kg/cm² wherein a blank is formed after heating about 5 to 15 minutes depending on the size and thickness of the mold; in step 204 convey the blank to an oven to bake in a temperature ranged from about 150° C. to 180° C. in a normal pressure about one atmosphere for foaming the blank wherein the baking time of the continuous sheet is about 10 to 30 minutes depending on the size of the blank, and the foamed blank is then conveyed from the oven; and in step 205 finally cool the foamed blank to produce the foam material having a predetermined shape.

In the embodiments of the invention the thermoplastic elastomeric material comprises the following components:

(1) Styrenic thermoplastic elastomer: The component is the raw material of the elastomeric material having a weight percentage about 50% to 100% selected from SBS, SEBS, SIS, or styrene ethylene propylene styrene (SEPS).

(2) Chemical foaming agent: The component having a percentage about 1% to 15% of the total weight of the polymeric raw material is selected from a chemical foaming agent (e.g., azodicarbonamide) or a physical foaming agent (e.g., sodium bicarbonate) wherein the polymeric raw material is comprised of styrenic thermoplastic elastomer and another polymeric material which, as an additive, has an amount taken as a percentage of the total weight of the polymeric raw material.

(3) Crosslinking agent: The component having a percentage about 0.1% to 1% of the total weight of the polymeric raw material is selected from a dicumyl peroxide, 2,5-(tert-butylperoxide)-2,5-dimethylhexane or sulfur.

The inventor takes advantage of the above components to continuously manufacture a thermoplastic elastomeric foam composite in a normal pressure (i.e., one atmosphere) in the above manufacturing processes. The foam material has the following advantages after being verified in experimentation:

(1) The invention is able to manufacture a novel, PVC free foam material having properties of both typical rubber foam and plastic foam materials without having to greatly modifying the prior manufacturing processes by utilizing a rubber continuous foam manufacturing technique and apparatus.

(2) The produced foam material of the invention has good elasticity and is slip resistant. Also, it is easy of coloring, has no smell of sulfuric rubber, can be recycled, and is wide in applications.

(3) The foam material of the invention has good post-processing capability. As such, it is subject to processing to form products having complicated shapes or patterns. Thus, it is particularly useful in producing products with mark, printing, and adhesive surfaces.

In addition, the invention does not limit the polymeric material as the same as above in practice. Rather, one skilled in the art may add the following components into the thermoplastic elastomeric material for manufacturing foam of the invention therefrom in atmosphere depending on desired capabilities, features, or applications.

(1) Any of other polymeric materials: The component having a percentage about 0% to 50% of the total weight of the polymeric raw material is selected from a styrene butadiene rubber (SBR), polystyrene (PS), ethylene vinyl acetate (EVA), low density polyethylene (LDPE), or ethylene-propylene-diene terpolymer rubber (EPDM) so as to improve the property of foam material for fulfilling the needs.

(2) Functional additive: The component having a percentage about 0% to 50% of the total weight of the polymeric raw material is selected from an anti-static agent, a combustion retardation agent, or a reinforced agent for improving the physical properties of the foam material.

(3) Accelerator for foaming agent: The component having a percentage about 0% to 3% of the total weight of the polymeric raw material is selected from a zinc oxide or urea for improving and accelerating the foaming.

(4) Any of other additives: The component is selected from oil, hard fatty acids or hard zinc based fatty acids as processing agent, coloring agent as an additive, calcium carbonate, or wood chips for changing the property of the foam material or changing a visual effect thereof.

While the invention has been described by means of specific embodiments, numerous modifications and variations could be made thereto by those skilled in the art without departing from the scope and spirit of the invention set forth in the claims.

1. A method of manufacturing a continuous foam from a thermoplastic elastomeric composite in atmosphere, comprising the steps of:
using a thermoplastic elastomer as a raw material;
adding different additive, foaming agent, and crosslinking agent into the raw material;
kneading and rolling the raw material for forming a continuous sheet by means of conventional rubber continuous foaming techniques and devices;
cutting the continuous sheet and weighing the sheatsto an oven;
foaming the heated sheet in a normal pressure; and
cooling the foamed sheet to produce the continuous foam.

2. The method of claim 1, wherein the thermoplastic elastomer as the raw material is selected from a styrenic thermoplastic elastomer including a styrene butadiene styrene (SBS), a styrene-ethylene/butene-styrene (SEBS), a styrene isoprene styrene (SIS), and a styrene ethylene propylene styrene (SEPS) having a percentage about 50% to 100% of the total weight of the raw material.

3. The method of claim 2, wherein the thermoplastic elastomer further comprises polymeric materials including styrene butadiene rubber (SBR), polystyrene (PS), ethylene vinyl acetate (EVA), low density polyethylene (LDPE), and ethylene-propylene-diene terpolymer rubber (EPDM) having a percentage about 0% to 50% of the total weight of the raw material.

4. The method of claim 2, wherein components of the thermoplastic elastomeric composite in a predetermined weight percentage are poured into the conventional devices for uniformly mixing by kneading and rolling in a temperature ranged from about 90° C. to 130° C.

5. The method of claim 4, wherein the continuous sheet is baked in the oven in a temperature ranged from about 150° C. to 180° C. in a normal pressure for a predetermined period of time for foaming the continuous sheet to produce a foam material.

6. The method of claim 2, wherein the foaming agent is selected from a chemical foaming agent (e.g., azodicarbonamide) or a physical foaming agent including sodium bicarbonate having a percentage about 1% to 15% of the total weight of the raw material.

7. The method of claim 6, wherein the crossling agent is selected from a dicumyl peroxide, 2,5-(tert-butylperoxide)-2,5-dimethylhexane or sulfur having a percentage about 0.1% to 1% of the total weight of the raw material.

8. The method of claim 7, wherein the thermoplastic elastomer further comprises accelarator for foaming agent selected from a zinc oxide or urea having a percentage about 0% to 3% of the total weight of the raw material.

9. The method of claim 7, wherein the thermoplastic elastomer further comprises a processing agent selected from stearate or hard zinc based stearate.

10. The method of claim 7, wherein the thermoplastic elastomer further comprises an additive including a coloring agent, a calcium carbonate, and wood chips.

11. The method of claim 7, wherein the thermoplastic elastomer further comprises an functional additive selected from an anti-static agent, a flame retardation agent, or a reinforced agent having a percentage about 0.1% to 50% of the total weight of the raw material.

12. A method of manufacturing a continuous foam from a thermoplastic elastomeric composite in atmosphere, comprising the steps of:
using a thermoplastic elastomer as a raw material;
adding different additive, foaming agent, and crosslinking agent into the raw material;
kneading and rolling above materials for forming a continuous sheet by means of conventional rubber continuous foaming techniques and devices;
cutting the continuous sheet into a plurality of sheet members with a predetermined size;
stacking a selected weight of the sheet members depending on requirements;
cutting the selected weight of the sheet members to a mold to heat for forming a blank;
cutting the blank to an oven to foam in a normal pressure; and
cooling the foamed blank to produce a foam material having a predetermined shape.

13. The method of claim 12, wherein the thermoplastic elastomer as the raw material is selected from a styrenic thermoplastic elastomer including styrene butadiene styrene (SBS), styrene-ethylene/butene-styrene (SEBS), styrene isoprene styrene (SIS), or styrene ethylene propylene styrene (SEPS) having a percentage about 50% to 100% of the total weight of the raw material.

14. The method of claim 13, wherein the components of the thermoplastic elastomeric composite in a predetermined weight percentage are poured into the conventional devices for uniformly mixing by kneading and rolling in a temperature ranged from about 90° C. to 130° C.

15. The method of claim 14, wherein responsive to uniformly mixing the components of the thermoplastic elastomeric composite, the uniformly mixed components of the thermoplastic elastomeric composite are transported to a two-roll mill for rolling a predetermined number of times to form a continuous sheet with required thickness prior to cutting into a plurality of sheet members with the predetermined size by means of an automatic cutter.

16. The method of claim 15, further comprising the steps of:
stacking a selected weight of sheet members having a required weight; and
cutting the selected weight of sheet members to the mold to heat in a temperature ranged from about 150° C. to 180° C. in a pressure about 90 to 250 kg/cm²,
wherein the blank is formed after heating a predetermined period of time.

17. The method of claim 12, wherein the foaming agent is selected from a chemical foaming agent (e.g., azodicarbonamide) or a physical foaming agent including sodium bicarbonate having a percentage about 1% to about 15% of the total weight of the raw material.

18. The method of claim 17, wherein the crosslinking agent is selected from a dicumyl peroxide, 2,5-(tert-butylperoxide)-2,5-dimethylhexane or sulfur having a percentage about 0.1% to 1% of the total weight of the raw material.

19. The method of claim 18, wherein the thermoplastic elastomer composite further comprises polymeric materials including styrene butadiene rubber (SBR), polystyrene (PS), ethylene vinyl acetate (EVA), low density polyethylene (LDPE), and ethylene-propylene-diene terpolymer rubber (EPDM) having a percentage about 0% to 50% of the total weight of the raw material.

20. The method of claim 18, wherein the thermoplastic elastomer composite further comprises a accelarator for foaming agent selected from a zinc oxide or urea having a percentage about 0% to 3% of the total weight of the raw material.

21. The method of claim 18, wherein the thermoplastic elastomer composite further comprises a processing agent selected from stearate or stearate.

22. The method of claim 18, wherein the thermoplastic elastomer composite further comprises an additive including a coloring agent, a calcium carbonate, and wood chips.

23. The method of claim 18, wherein the thermoplastic elastomer composite further comprises an functional additive selected from an anti-static agent, a flame retardation agent, or a reinforced agent having a percentage about 0% to 50% of the total weight of the raw material.
